(19) United States
(12) Patent Application Publication
(10) Pub. No.: US 2002/0055875 A1
(43) Pub. Date: May 9, 2002

(54) Coupon redemption system

(76) Inventors: Everett E. Schulze JR., Aurora, CO (US); Melissa Mary Schulze, Littleton, CO (US)

Correspondence Address: SHERIDAN ROSS PC, 1560 BROADWAY, SUITE 1200, DENVER, CO, 80202

(21) Appl. No.: 09/909,103

(22) Filed: Jul. 12, 2001

Related U.S. Application Data
(63) Continuation-in-part of application No. 09/250,207, filed on Feb. 16, 1999, now abandoned.
(63) Continuation-in-part of application No. 09/626,345, filed on Jul. 26, 2000.

(51) Int. Cl. G06F 17/60

(52) U.S. Cl. 705/14

(57) ABSTRACT

A system for processing coupons includes a coupon scanner for reading information from a coupon and a host processor for using the information to determine whether the coupon is valid. The coupon scanner includes a coupon modification unit for use in modifying valid coupons so that the coupons are no longer redeemable. The coupon scanner also includes a coupon sorter for sorting valid coupons between the coupon modification unit and an audit lock box unit that stores unmodified valid coupons for eventual audit. The system further includes a rejected coupon lock box unit for temporarily storing selected coupons that were rejected by the coupon scanner but which were still redeemed by store personnel. The stored rejected coupons are later analyzed by a third party service provider to determine if they were validly redeemed by the store.

This is a continuation-in-part (CIP) of U.S. patent application Ser. No. 09/250,207 filed Feb. 16, 1999, and a continuation-in-part (CIP) of U.S. patent application Ser. No. 09/262,345 filed Jul. 26, 2000.

### FIELD OF THE INVENTION

The present application relates in general to systems for tracking customer purchase transactions and, more particularly, to systems for accurately accounting for coupon usage during such customer transactions.

### BACKGROUND OF THE INVENTION

Product manufacturers generally distribute coupons as a marketing tool to encourage consumers to purchase their products. The coupons are distributed to consumers through any of a number of different channels, including print media, circulars, direct mailings, e-mail, and the Internet. To redeem a coupon, a consumer must generally purchase an identified product at a retail establishment. The consumer hands the coupon to the checkout clerk who then reduces the total amount owed by the consumer based on the amount stated on the face of the coupon. The retail establishment is then reimbursed by the product manufacturer for the face value of the coupon plus a coupon handling fee.

Although not apparent to consumers, the coupon redemption process is relatively complex, involving many processing stages. The complexity of the process is due to the fact that the manufacturers who issue the coupons want to be relatively certain that the coupons have been properly redeemed before they reimburse the retail establishments. That is, the product manufacturers are concerned that “misredemptions” might occur where a retail establishment is reimbursed for coupons that were not redeemed according to the conditions on the coupon. These “misredemptions” can occur unintentionally through, for example, employee error or intentionally through, for example, the perpetration of a fraud by someone in the coupon redemption chain. In general, if a manufacturer suspects that one or more coupons have been misredeemed, the manufacturer will hold back payment to the retail establishment for the subject coupon(s) until the matter is investigated (this is known in the industry as a chargeback). The retailers are generally irritated by these chargebacks and will sometimes take retaliatory action by, for example, deducting all chargebacks from the manufacturer's product invoice. As can be appreciated, this situation can seriously strain the relationship between the retailer and the manufacturer.

Many fixes have been proposed and/or implemented for making the coupon redemption process more reliable, more efficient, and more automated. However, none of these fixes have provided a system whereby all manufacturers' coupons, from all sources, can be handled in an efficient and accurate manner. In addition, none of these fixes are capable of providing a retailer with an almost immediate reimbursement of funds for coupons redeemed by the retailer.

### SUMMARY OF THE INVENTION

The present invention relates to a system for accurately, efficiently, and predictably managing virtually any coupon that is presented by a customer at a retail establishment or store. In most cases, the system will provide an almost immediate reimbursement to the store (e.g., same day) for coupons properly redeemed by the store. The system is capable of significantly reducing coupon misredemptions and the costs that go along with them. In addition, the system provides an enhanced level of redemption data collection that can be used, for example, to generate detailed reports for the manufacturers. Further, the system provides procedures for handling almost any type of coupon that exists, including hard-to-handle coupons and coupons that are to be audited.

The system includes equipment that is capable of automatically and accurately determining the validity of coupons presented by a customer. The system also includes equipment for modifying valid coupons so that they cannot be used again in the future. In addition, the system includes the ability to maintain some of the valid coupons in an unmodified form for later manual processing such as, for example, a periodic manual audit. After a coupon has been deemed valid, the customer's total purchase price is reduced in the amount stated on the coupon. A decision is then made as to whether any future manual processing is to be done. If additional processing is desired, the coupon is delivered unmodified to a storage unit and details of the customer transaction are recorded. If no additional processing is required, the coupon is modified and the store is credited for the valid redemption. At the end of each day (or other appropriate time), the store is reimbursed for all coupons that have been validly redeemed and modified that day. The store is reimbursed for the coupons in the storage unit after the coupons have been manually processed aid verified.

When the above-described equipment determines that a coupon is invalid, the checkout clerk is given an opportunity to override the equipment by entering coupon information into the system by other means. In such a case, the customer is still given the price reduction, but the store does not receive immediate credit for the redemption. Thus, the store is not reimbursed for the redemption at the end of the day. Instead, the coupon is placed in a rejected coupon lock box at the checkout station for later verification and details of the transaction are recorded. Periodically, the contents of the rejected coupon lock box are retrieved and the coupons are verified using the stored transaction information. If the coupons are found valid, the store is credited in the proper amount and payment is accordingly made. If some of the coupons are found to be invalid, the store does not receive credit for the redemption.

In a preferred embodiment, the system is maintained (at least partially) under the control of a third party service provider which acts as a intermediary between the store and the manufacturers. That is, the third party service provider has sole access to the storage unit and the rejected coupon lock box and performs all manual verification functions. In addition, the third party service provider has control over the internal workings of the coupon redemption equipment within the store. Because the third party service provider controls the coupon redemption equipment within the store, the possibility of fraudulent misredemptions by store personnel are greatly reduced. Payments to the store for validly redeemed coupons are preferably made by the third party service provider. The third party service provider is then reimbursed by the appropriate manufacturers. Accurate records are maintained for all coupon redemptions and all manual verifications. These records are made available to the manufacturers upon request.

### BRIEF DESCRIPTION OF THE DRAWINGS

FIG. 1 is a block diagram illustrating a system in accordance with one embodiment of the present invention;

FIG. 2 is a block diagram illustrating a coupon scanner that can be used in the system of FIG. 1;

FIG. 3 is a flowchart illustrating steps related to processing coupons including rejected coupons;

FIG. 4 is a flowchart illustrating steps related to processing coupons including modified coupons and audit coupons;

FIG. 5 is a block diagram of a coupon redemption system of another embodiment;

FIG. 6 is a block diagram of a point of sale system useable with the embodiment of FIG. 5;

FIG. 7 is a block diagram of a coupon redemption subsystem for the embodiment of FIG. 5;

FIG. 8 is a flowchart illustrating major steps taken in redeeming coupons according to the embodiment of FIG. 5;

FIG. 9 is a flowchart of the operation of a coupon redemption system according to the embodiment of FIG. 5;

FIG. 10 is a flowchart of the coupon verification process according to the embodiment of FIG. 5;

FIG. 11 is a representative example of a retailer report, release and check in accordance with the embodiment of FIG. 5;

FIG. 12 is a flowchart representing flow of information for coupons redeemed according to the embodiment of FIG. 5; and

FIG. 13 is a representative invoice to a manufacturer by a third party coupon verifier for coupons purchased by the third party verifier from a retailer.

### DETAILED DESCRIPTION

The present invention relates to a system for accurately, efficiently, and predictably managing virtually any coupon that is presented by a customer at a retail establishment or store. The system is capable of providing rapid reimbursement to the store for coupons validly redeemed by the store. In addition, the system is capable of operating with minimal inconvenience or delay to store customers who are given immediate credit for valid coupons. Further, the system interferes as little as possible with the normal internal functioning of the store. The system is capable of significantly reducing the complexity and duration of the typical coupon redemption process.

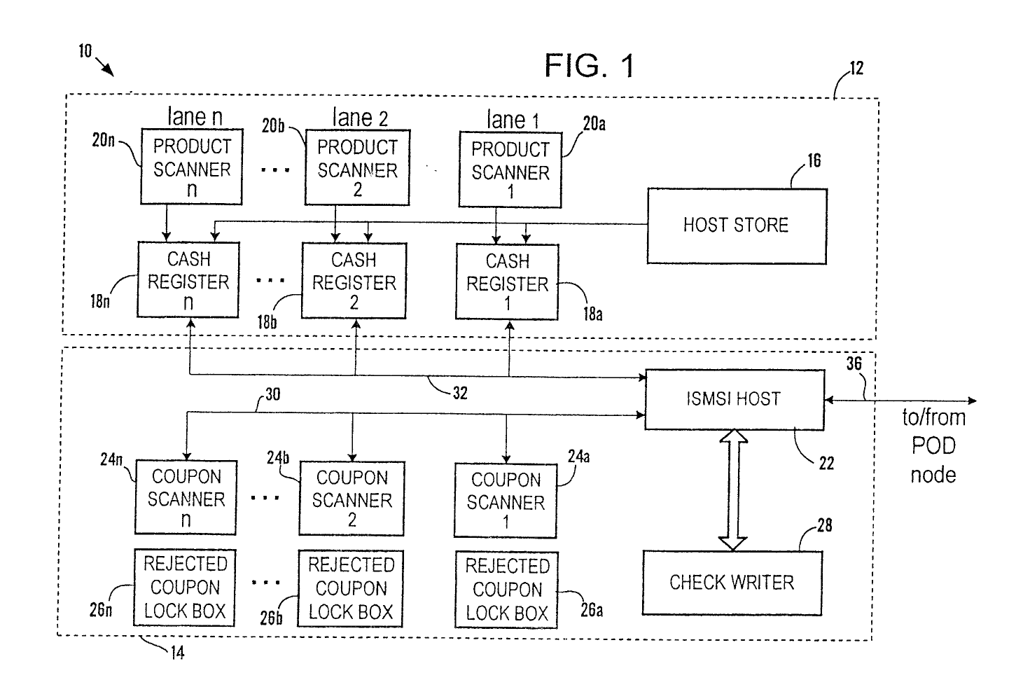

FIG. 1 is a block diagram illustrating a system 10 in accordance with one embodiment of the present invention. The system 10 is implemented within a retail establishment or store. As shown, the system 10 is partitioned into two operative subsystems; namely, the store equipment 12 and the ISMSI equipment 14. The store equipment 12 is operative for processing and recording information related to customer purchases at the store. The ISMSI equipment 14 is coupled to the store equipment 12 for use in processing coupons presented by customers during product purchase transactions. The ISMSI equipment 14 is designed to work with the store equipment 12 to provide a reliable, efficient, and cost effective method for verifying and redeeming manufacturer coupons and for facilitating and expediting the payment of the store by the manufacturer for properly redeemed coupons.

In a preferred approach, the store equipment 12 is maintained under the control of the store. That is, the store will own the equipment 12 and will be responsible for the maintenance, repair, and proper operation of the equipment 12. Accordingly, the store will have access to all parts of the store equipment 12 for whatever reason necessary. Conversely, the ISMSI equipment 14 will be under the control of a third party service provider, such as In-Store Media Systems, Inc. (ISMSI), the assignee of the present invention. As will be described in greater detail, the store will preferably have only limited access to the elements within the ISMSI equipment 14. In one embodiment, for example, store access is limited to an external operational level, wherein store personnel are only permitted to perform external operations with the equipment 14 (such as inserting coupons into a unit) and simple maintenance operations (such as clearing paper jams and the like). All other maintenance and repair functions are performed by the third party service provider, which preferably maintains title to the equipment 14.

As illustrated in FIG. 1, the store equipment 12 includes the basic equipment normally utilized by a store having n checkout lanes. That is, the store equipment 12 includes: a store host 16, a plurality of cash registers 18a-18n, and a plurality of product scanners 20a-20n. Each of the checkout lanes of the store includes one cash register 18 and one product scanner 20 for use in processing customer purchases. The cash register 18 can include a standard type register, a personal computer controlled terminal, or any other means of receiving and tracking data. The product scanner 20 is a device for optically recognizing products being purchased by a customer by sensing, for example, indicia on the product packages. The store host 16 is coupled to each of the plurality of cash registers 18a-18n for, among other things, controlling the operation of the cash registers 18a-18n.

When a customer wishes to checkout, the customer brings the products he/she wishes to purchase to the checkout clerk in one of the lanes (e.g., lane 1). The checkout clerk “scans” each of the products using the product scanner 20a which reads a universal product code (UPC) on the package of each product. The product scanner 20a then transfers the UPC information to the corresponding cash register 18a which, among other things, tallies the price of the products. The clerk eventually informs the customer of the total price for the selected products and the customer then pays for the products by some acceptable payment method, thus terminating the transaction. At some point in the checkout procedure, the clerk asks the customer if he/she has any coupons. If the customer has coupons, the clerk must first process the coupons using the ISMSI equipment 14 before payment is requested. The method for processing the coupons using the ISMSI equipment 14 will be described below in greater detail.

In one embodiment of the present invention, the store equipment 12 is free standing with respect to the ISMSI equipment 14. That is, the store equipment 12 is purchased separately by the store and is later retrofitted or modified to operate with the ISMSI equipment 14. In another embodiment, the store equipment 12 and the ISMSI equipment 14 are sold/leased as an integral system, possibly within a single housing.

With reference to FIG. 1, the ISMSI equipment 14 includes: an ISMSI host 22, a plurality of coupon scanners 24a-24n, a plurality of rejected coupon lock boxes 26a-26n, and a check writer unit 28. In the preferred embodiment, each checkout lane in the store includes one coupon scanner 24 and one rejected coupon lock box 26. The coupon scanners 26a-26n are each coupled to the ISMSI host 22 via an appropriate transmission medium 30. The transmission medium 30 can include virtually any form of medium (wired or wireless) that is capable of transferring data/commands between the ISMSI host 22 and the corresponding scanners 24a-24n. For example, in one embodiment of the invention, a wired bus arrangement using a conventional or standard bus structure is implemented. In another embodiment, each of the coupon scanners 24a-24n is separately hard wired to the ISMSI host 22. In still another embodiment, a plurality of wireless links are provided. Depending on the medium used, an appropriate multiple access scheme may also be implemented.

As shown in FIG. 1, the ISMSI host 22 is also coupled to the cash registers 18a-18n via a second transmission medium 32. The second transmission medium 32 can be of the same type as the first transmission medium 30, or a different type of medium can be used. In the illustrated embodiment, the ISMSI host 22 is directly coupled to the cash registers 18a-18n. In an alternate embodiment, the ISMSI host 22 is coupled to the cash registers 18a-18n through the store host 16. The ISMSI host 22 is further coupled to a planned operations development (POD) node located outside the store. The link 36 between the ISMSI host 22 and the POD node can include virtually any form of transmission medium, either wired or wireless. The POD node is maintained by the third party service provider and is normally used to service multiple store locations. In addition, the POD node is linked into the corporate host of the third party service provider for use in data gathering/analysis/reporting functions.

The ISMSI host 22 is operative for determining whether coupons inserted into the coupon scanners 24a-24n are valid and redeemable and, if so, for transferring the coupon information to the appropriate cash register 18. The ISMSI host 22 is also operative for managing the disposition of the coupon after it has been analyzed and for sharing information with the external POD node, among other things. In a preferred embodiment, the ISMSI host 22 includes a digital processor unit. The digital processor unit can include virtually any form of digital processor including, for example, a general purpose microprocessor, a digital signal processor (DSP), a reduced instruction set computer (RISC), or a complex instruction set computer (CISC).

During a customer transaction, the ISMSI host 22 receives information from a corresponding cash register 18 identifying all of the items being purchased by the customer. The ISMSI 22 host stores this information in an internal memory. If the customer presents a coupon to the checkout clerk, the clerk inserts the coupon into the coupon scanner 24 for analysis. The coupon scanner 24 “reads” information from the coupon that identifies at least the product associated with the coupon and the applicable discount. The coupon scanner 24 then transfers this information to the ISMSI host 22 which analyzes the information to determine whether the coupon should be redeemed. As part of the analysis, the ISMSI host 22 compares the product identified by the coupon to the list of products being purchased by the customer. If the identified product is being purchased by the customer, the ISMSI host 22 performs one or more further tests (as will be described in greater detail) to determine whether the coupon is redeemable. If it is found that the coupon is redeemable, the ISMSI host 22 transfers the redemption information to the appropriate cash register 18 which subtracts the proper amount from the customer's total. The ISMSI host 22 then instructs the coupon scanner 24 to store the coupon in an appropriate form. If the coupon is not found to be redeemable, the ISMSI host 22 instructs the coupon scanner 24 to eject the coupon out of its input port. The ejected coupon is then manually entered by the clerk or is returned to the customer.

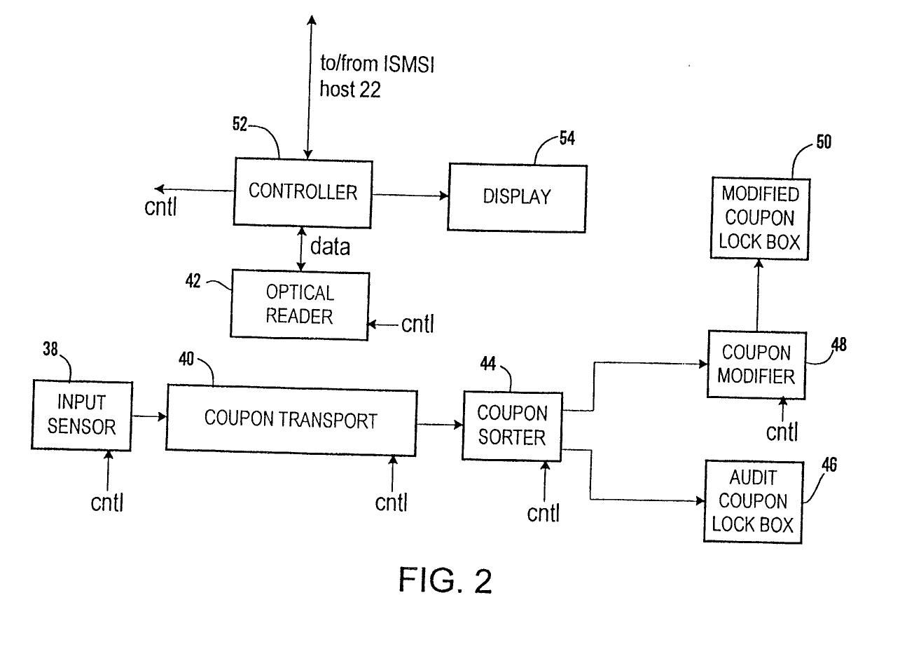

FIG. 2 is a block diagram illustrating a coupon scanner 24 in accordance with one embodiment of the present invention. As shown, the coupon scanner 24 includes: an input sensor 38, a motorized coupon transport unit 40, an optical reader 42, a coupon sorter 44, an audit coupon lock box 46, a coupon modifier 48, a modified-coupon lock box 50, a controller 52, and a display 54. The controller 52 is operative for controlling the operation of the other elements within the coupon scanner 24. In addition, the controller 52 is coupled to the ISMSI host 22 via transmission medium 30 for communicating with the host 22 during customer transactions. The input sensor 38 is operative for sensing the presence of a coupon at the input port of the coupon scanner 24. When a coupon is sensed, the input sensor 38 signals the controller 52 which causes the coupon transport unit 40 to advance the coupon to a position where it can be read by the optical reader 42. It should be appreciated that once the coupon is inside the coupon scanner 24, the coupon is under the control of the third party service provider and is no longer under the control of the store clerk.

The optical reader 42 scans the coupon as it passes beneath it to optically detect indicia on the coupon that identifies the conditions for proper redemption of the coupon. For example, information such as product identity, package size, manufacturer, quantity, expiration date, and discount amount may be sensed. Other forms of information can also be read from the coupon. In one embodiment of the invention, the optical reader 42 reads a bar code from the coupon (e.g., a UPC bar-code) that includes the necessary information. Alternatively, or in addition, the optical reader 42 can include an imaging unit for use in recognizing images on the coupon. This imaging functionality can be useful in detecting, for example, coupon forgeries and the like. The controller 52 retrieves the coupon information from the optical reader 42, converts it to an appropriate format (optional), and transfers it to the ISMSI host 22. The ISMSI host 22 then uses the information to determine whether the coupon should be redeemed. The decision of the ISMSI host 22 is then transferred back to the controller 52 via transmission medium 30.

If the ISMSI host 22 determines that the coupon is not to be redeemed, the controller 52 causes the coupon transport unit 40 to eject the coupon out of the input port of the coupon scanner 24. The controller 52 then displays a message on the display 54 explaining the reason for the rejection of the coupon to the clerk. If the coupon is found to be redeemable by the ISMSI host 22, the controller 52 instructs the coupon transport unit 40 to advance the coupon to the coupon sorter 44. The controller 52 then instructs the coupon sorter 44 how to appropriately direct the coupon. Most of the time, the coupon is directed to the coupon modifier 48 which modifies the coupon in a manner that prevents the coupon from ever being redeemed again in the future. In a preferred embodiment of the invention, the coupon modifier 48 is a shredder that shreds the coupon into a multitude of small pieces. After the coupon has been modified, the modified coupon is advanced into a modified coupon lock box 50 for temporary storage. As described earlier, the modified-coupon lock box 50 is preferably maintained under the control of the third party service provider (e.g., the key to the lock box 50 is held by the third party service provider).

In certain instances, a coupon that is found redeemable by the ISMSI host 22 will be held unaltered by the coupon scanner 24 for the performance of further processing, such as a manufacturer's audit. In such cases, the coupon sorter 44 will be instructed to direct the coupon to the audit lock box 46 which is under the control of the third party service provider. Typically, a manufacturer will request the third party service provider to store certain coupons for audit as part of an analysis of some type. For example, the manufacturer may request that all coupons that have a specified offer code and that are redeemed at a particular store (or chain of stores) during a particular time period be held for audit. The third party service provider then transfers this information to the ISMSI host 22 (via, for example, the POD node) which refers to this information during the analysis of coupons. When a coupon that matches the audit criteria is detected by the ISMSI host 22, the ISMSI host 22 delivers information to the controller 52 which causes the coupon to be directed to the audit lock box 46. The ISMSI host 22 then records information about the customer transaction for later use during the audit. The information can include, for example, lane number, cashier, date, time, products(s) purchased, price of product(s) purchased, and other relevant information. Normally, the coupon disposition process for redeemable coupons will be transparent to the customer. That is, the customer will get an immediate credit for the coupon when it is found valid, regardless of whether it is then modified or held for audit. The disposition of the coupon will, however, affect the timing of the reimbursement from the manufacturer to the store.

When a redeemed coupon has been modified by the coupon scanner 24, the ISMSI host 22 adds the amount of the discount given for the coupon to a particular manufacturer's account. The amount of the manufacturer's account plus coupon handling fees is then paid to the store at a specified time, preferably the end of the corresponding business day. Because the coupon has been found valid and redeemable by the equipment of the third party service provider, and was subsequently modified, the payments can be made immediately without further verification by the manufacturer or its agents. The payment is preferably made to the store by the third party service provider which is later reimbursed by the manufacturer.

In one embodiment of the invention, as illustrated in FIG. 1, the ISMSI equipment 14 located at the store includes a secure check writer 28 that is connected to the ISMSI host 22. At the end of a business day, for example, the ISMSI host 22 will send information to the POD node corresponding to all of the different manufacturers' accounts for that day. The POD node then instructs the ISMSI host 22 to have the check writer 28 write a check to the store in an amount corresponding to the total of all of the manufacturers' accounts (plus handling fees). The POD node then transfers the manufacturer information to the corporate host so that the manufacturers can be billed in the appropriate amount. In an alternate embodiment, the ISMSI host 22 automatically causes the check writer 28 to generate the check at the end of the day, independent of the POD node. In this embodiment, the ISMSI host 22 transfers the relevant data to the POD node after or concurrent with the payment. In another payment approach, the POD node causes a wire transfer to be made to a bank account of the store after the manufacturer account information is received from the ISMSI host 22. Preferably, both payment techniques are made available. Other payment techniques are also possible.

Redeemed coupons that are placed in the audit coupon lock box 46 are not reimbursed at the end of the business day. These coupons are manually processed by employees of the third party service provider during periodic audit sessions. The employees generally visit the store and retrieve all of the coupons from the audit lock boxes in each of the checkout lanes. The audit coupons are kept segregated according to lane. The coupons are brought back to a corresponding POD location where they are processed manually. During the audit, the third party service provider employee will normally refer to the transaction information that was recorded by the ISMSI host 22 during the relevant transactions. This information can be fetched from the ISMSI host 22 using, for example, the POD node or periodic automatic downloads to the POD node can be made. If the audit coupons are found to be valid, the store's account is credited in the amount of these coupons. If some of the audit coupons are found to be invalid, these coupons are returned to the store with appropriate reasons for the rejection. After manual processing is complete, relevant information is delivered to the corporate host for use in analysis/reporting. After audit, the validated coupons will either be destroyed or returned to the manufacturer. The manufacturer will normally indicate which disposition it desires.

Coupons can be rejected by the ISMSI host 22 (and therefore ejected by an associated coupon scanner 24) for numerous reasons. For example, it may be found that the customer did not purchase the product identified by the coupon or the correct product size. Similarly, it may be found that the coupon has expired or that some other condition stated on the coupon has not been satisfied (such as quantity purchased or other item purchased). Other times, the third party service provider or the store may find out that a particular manufacturer has gone out of business or filed for bankruptcy. A decision can then be made not to honor coupons issued by that manufacturer and the ISMSI host 22 is programmed to reject all coupons from that manufacturer. Hard-to-handle (HTH) coupons may also be ejected by the coupon scanner 24. That is, certain coupons may be in a condition that does not allow them to be properly processed by the coupon scanner 24. For example, torn, wet, flimsy, smeared, and/or very odd-shaped coupons may be rejected by a coupon scanner 24 if they are causing jams or misreads to occur in the unit.

When a coupon is rejected by the ISMSI host 22, it is ejected from the coupon scanner 24 and the reason(s) for the rejection is displayed on the display 54 of the coupon scanner 24. The checkout clerk reads the display and makes a determination as to whether the coupon will still be redeemed. The store can issue guidelines to the clerks specifying conditions under which coupons should still be redeemed when ejected from the coupon scanner 24. If the coupon is simply an HTH coupon, the clerk can decide to accept the coupon if, for example, the conditions stated on the coupon have been satisfied. Also, if the clerk believes that a particular customer may become irate if a coupon is rejected, the clerk may be authorized to redeem the coupon, whether valid or not. Once the decision has been made to redeem the rejected coupon (“override coupon”), the clerk enters the coupon information into the system either manually at the cash register 18 or by scanning it with the product scanner 20 (see FIG. 1). In addition, alternative data entry means, such as a wand reader, may be provided for entering the rejected coupon information. As with the audited coupons, rejected coupons that have been manually entered by the clerk are not reimbursed to the store by the third party service provider at the end of the day.

After the rejected coupon information has been entered into the system, the clerk places the coupon into the rejected coupon lock box 26 and the ISMSI host 22 records information about the transaction for later use in manually validating the coupon. For example, the ISMSI host 22 will normally record the date, time, and lane of the transaction. In addition, the ISMSI host 22 may record the items purchased during the transaction and the purchase price of the items. Periodically, the contents of the rejected coupon lock boxes 26a-26n are retrieved by employees of the third party service provider and manually processed as described previously with respect to the audit lock box 46. As will be described later, such coupons maybe processed using a separate system that is preferably located at the retail outlet. Preferably, the audit coupons and the rejected coupons will be processed during the same session. The employees of the third party service provider will generally access the information stored by the ISMSI host 22 during the relevant transactions as part of the validation process. The store will be credited for of the rejected coupons that are found to be valid by the third party service provider. In addition, explanations will be given to the store for all coupons found to be invalid. Payment to the store will be made by the usual methods.

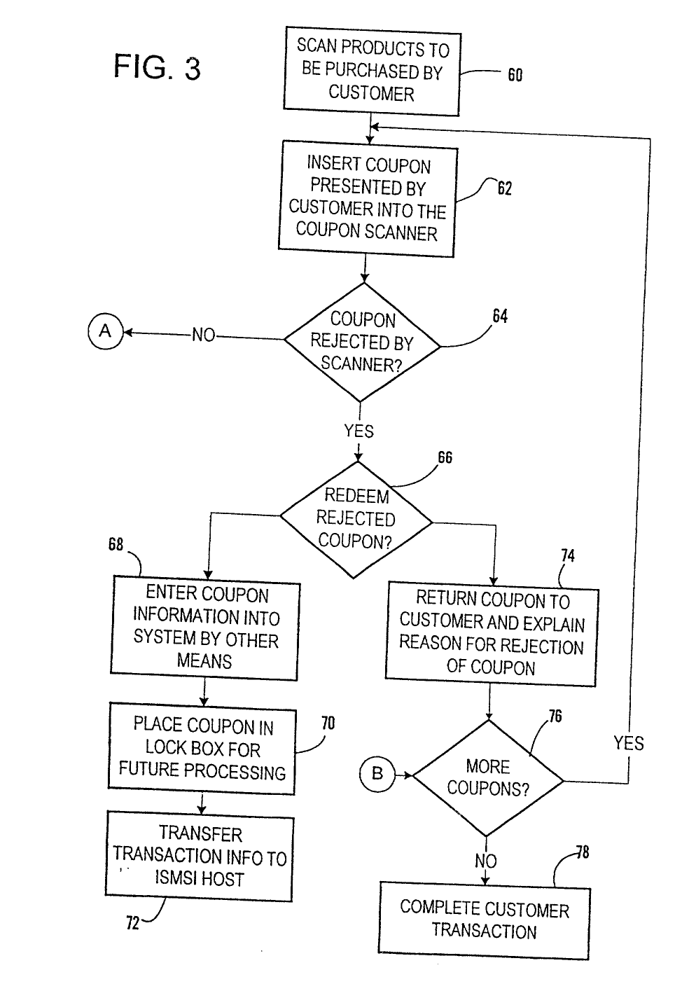

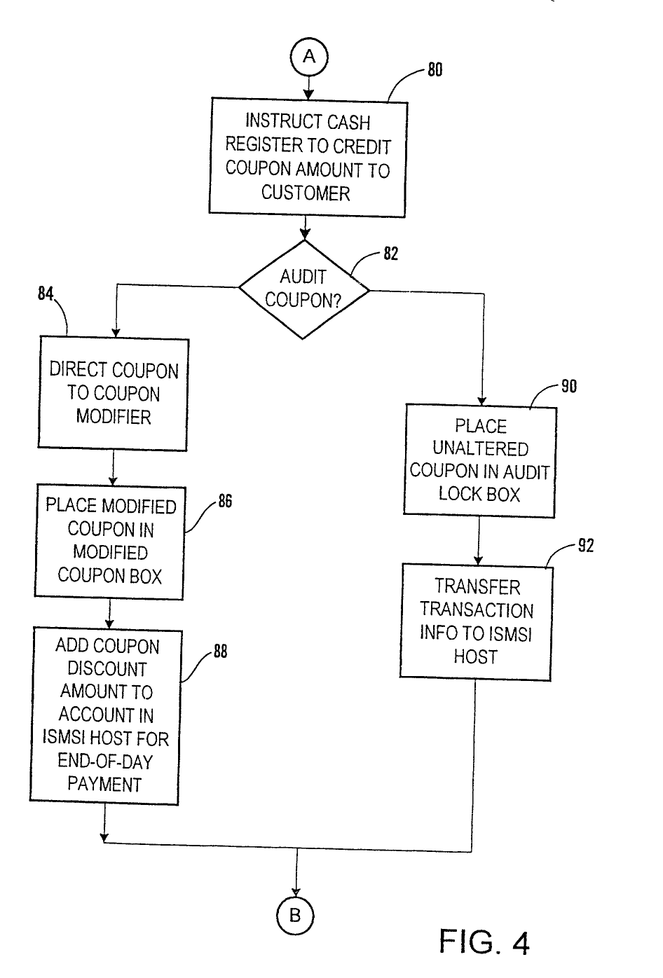

FIGS. 3 and 4 are flowcharts illustrating a method for processing customer purchases in accordance with one embodiment of the present invention. The method is initiated when a customer brings one or more products for purchase to a checkout clerk. With reference to FIG. 3, the clerk scans the products presented by the customer using product scanner 20 (step 60). As described previously, the scanned product information is transferred from the product scanner 20 to the corresponding cash register 18 and the ISMSI host 22. After scanning the products, the clerk inserts the first customer coupon into the coupon scanner 24 (step 62). Based on a decision of the ISMSI host 22, the coupon scanner 24 either keeps or rejects the coupon (step 64).

If the coupon is rejected, the checkout clerk reads the reason(s) for the rejection from the display 54 and makes a determination as to whether the coupon will still be redeemed (step 66). If the clerk decides to redeem the coupon, the clerk then enters the coupon information into the system either manually at the cash register, by scanning it using the product scanner 20, or using some other input device (step 68). The clerk then deposits or otherwise initiates locating the coupon in the rejected coupon lock box 26 for later manual verification (step 70). Information relating to the customer transaction is then transferred from the cash register 18 to the ISMSI host 22 for storage and eventual use by third party service provider personnel during manual verification (step 72). If the clerk decides that the rejected coupon will not be redeemed (step 66), then the coupon is returned to the customer along with an explanation as to why the coupon was rejected (step 74). After the rejected coupon has been fully processed, the clerk determines whether there are additional coupons to be entered (step 76). If so, the clerk inserts the next coupon into the coupon scanner 24 and the method is repeated (step 62). If not, the clerk completes the customer transaction by telling the customer what the final total is and accepting payment from the customer (step 78).

If the entered coupon is not rejected by the coupon scanner 24 (step 64), the ISMSI host 22 instructs the cash register 18 to credit the customer for the amount stated on the coupon (step 80, see FIG. 4). The ISMSI host 22 then determines whether the coupon is to be audited (step 82). In one embodiment of the invention, this determination includes a comparison of information read from the coupon to a list of audit coupon types. The determination may also include a comparison of the present date to an applicable audit period. If the coupon is to be audited, the ISMSI host 22 causes the coupon sorter 44 (via the controller 52) to direct the coupon into the audit coupon lock box 46 (step 90). The appropriate customer transaction information is then transferred to the ISMSI host 22 from the cash register 18 for eventual use by third party service provider personnel during manual verification (step 92).

If the ISMSI host 22 determines that the coupon is not to be audited (step 82), the coupon sorter 44 is instructed to direct the coupon to the coupon modifier 48 (step 84). As described above, in a preferred embodiment, the coupon modifier 48 includes a shredder for shredding the coupon into an unusable state. This shredding ensures that the coupon will never be redeemed again by a customer. The modified coupon is then placed into the modified coupon lock box 50 (step 86) where it stays until retrieved and disposed of by the third party service provider. After coupon modification, the amount of the coupon discount is recorded in the ISMSI host 22 for payment to the store at the end of the day or other relevant time (step 88). After the non-rejected coupon has been fully processed, the clerk determines whether there are additional coupons to be entered (step 76, see FIG. 1). If so, the clerk inserts the next coupon into the coupon scanner 24 and the method is repeated (step 62). If not, the clerk completes the customer transaction by telling the customer what the final total is and accepting payment from the customer (step 78).

As is apparent from the above description, the present invention relates to a system for processing customer purchase transactions that is capable of handling any form of coupon that is presented by the customer. In the preferred embodiment, the coupon scanner 24 is capable of reading virtually any coupon format presently used in the retail industry. That is, the scanner 24 can read coupons of any standard size with a bar code (or other indicia) located virtually anywhere and in virtually any orientation on the face of the coupon. In some cases, a coupon will be presented to a checkout clerk that is in a condition that makes it hard-to-handle by the coupon scanner 24. Processes are provided whereby such coupons are uniformly and accurately managed by the store and the third party service provider. The system is capable of achieving very rapid reimbursement (e.g., end-of-day payments) to the store for most properly redeemed coupons. In addition, the system provides standardized, predictable, and automatic procedures for handling all other coupons, such as audited coupons, hard-to-handle coupons, and coupons that can not be properly read by an optical reader (e.g., smudged coupons).

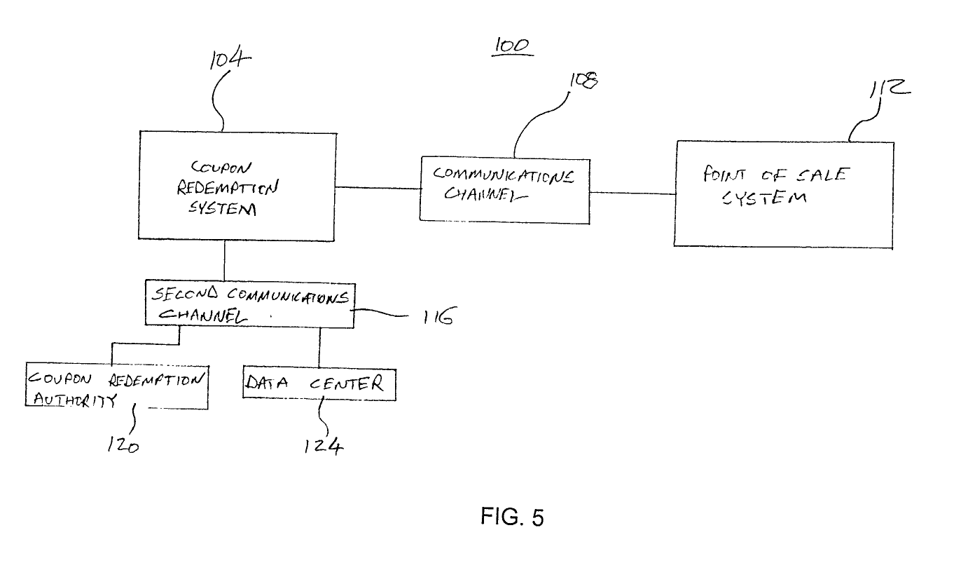

Referring to FIG. 5, a related coupon redemption system 100 is disclosed including a coupon redemption subsystem 104. The subsystem 104 can be, among other things, involved with processing coupons at a location away from the purchasing outlet or check-out lanes of a retail outlet, but with the subsystem 104 still being relatively close thereto. In one embodiment, the coupon redemption subsystem 104 is located in the retail outlet itself, such as in a separate room or office in a grocery store. As will be described subsequently, a number of verifying coupons are provided as inputs to the subsystem 104 in connection with deciding what appropriate steps should be taken. In the context of the invention described in conjunction with FIGS. 1-4, the one or more verifying coupons can include rejected coupons (override coupons) that are removed from the rejected coupon lock box 26 by a representative of the third party service provider (different from the retail outlet entity and different from the product manufacturer or provider who authorizes the coupon) and taken to the coupon redemption subsystem 104.

As seen in FIG. 5, the coupon redemption system 100, in addition to the auxiliary computer or coupon redemption subsystem 104, includes a communications channel 108 and a point of sale (POS) subsystem 112. The system 100 may also include a second communications channel 116, which may be used to interconnect the coupon redemption subsystem 104 to a coupon redemption authority 120 and/or to a data center 124.

The communications channel 108 serves to transfer information between the coupon redemption subsystem 104 and the point of sale subsystem 112. Accordingly, the communications channel 108 may comprise a computer network, such as a local area network (LAN), for example an Ethernet network, or a wide area network (WAN), for example the Internet or a token ring configuration or any other acceptable communication setup and/or protocol. The channel 108 may also comprise standard or proprietary serial or parallel type interconnections. The channel 108 cooperates with appropriate communications interfaces 216 and 316 provided as part of the point of sale 112 and coupon redemption 104 subsystems, respectively.

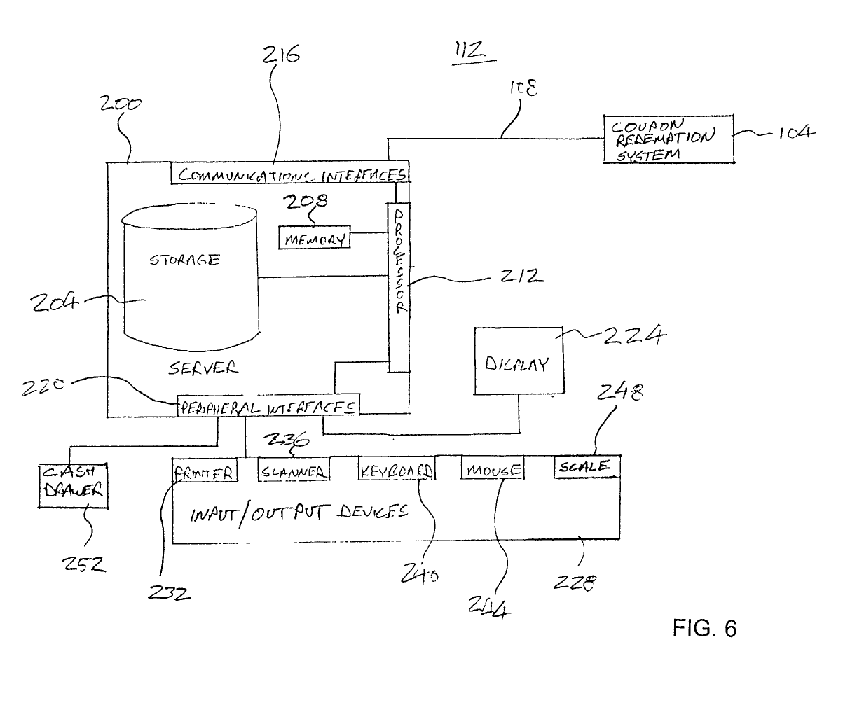

In general the point of sale subsystem is used to track sales of retail goods to consumers. FIG. 6 represents a point of sale subsystem 112 useable with the coupon redemption subsystem 104 of the present invention. In general, the point of sale subsystem 112 includes a server 200 having associated storage 204, memory 208 and a processor 212. In addition, the server 200 may include communications 216 and peripheral 220 interfaces as required by the particular communications channel 108 and peripheral devices interconnected to the server 200. In a typical point of sale subsystem 112, the server 200 includes an Intel Pentium™ class processor 212 with a suitable hard disk and/or tape drive as the storage 204 and 64 Mb of solid state memory 208.

The peripheral devices associated with the point of sale subsystem 112 may include a display 224, such as a cathode ray tube or flat panel type display, and any one of a variety of input/output devices 228. The input/output devices 228 may include a printer 232, a scanner 236, a keyboard 240, a mouse 244 and a scale 248. The subsystem 112 may also be interconnected to a cash drawer 252.

In operation, the point of sale subsystem 112 is used to record sales of items to consumers. Accordingly, information regarding each product sold to a consumer is entered into the point of sale subsystem 112 using one or more of the input/output devices 228. For example, a cashier at a check-out station or point of sale may read a universal product code (UPC) using the scanner 236. The information read from the UPC may then be stored in the computer storage 204 of the server 200. If the consumer presents a coupon associated with the product, the cashier may discount the amount due from the consumer by the face value of the coupon. The value of the coupon may be entered into the point of sale subsystem 112 by scanning a bar code from the coupon using the scanner 236, a separate scanner, reader or other input device, or the cashier may enter the information manually by, for example, entering the amount of the discount using the keyboard 240. Information regarding redeemed coupons or discounts entered by the cashier may also be stored in the computer storage 204. As can be appreciated, there is usually a number of check-out stations. At each check-out station, a cashier is involved with checking out products being purchased and redeeming associated coupons for one or more of such products. Each of the check-out stations typically has its own scanner for handling the sales of products having UPCs. Each such scanner, and/or another coupon reader separate from the scanner, is used to input coupon information to the server 200.

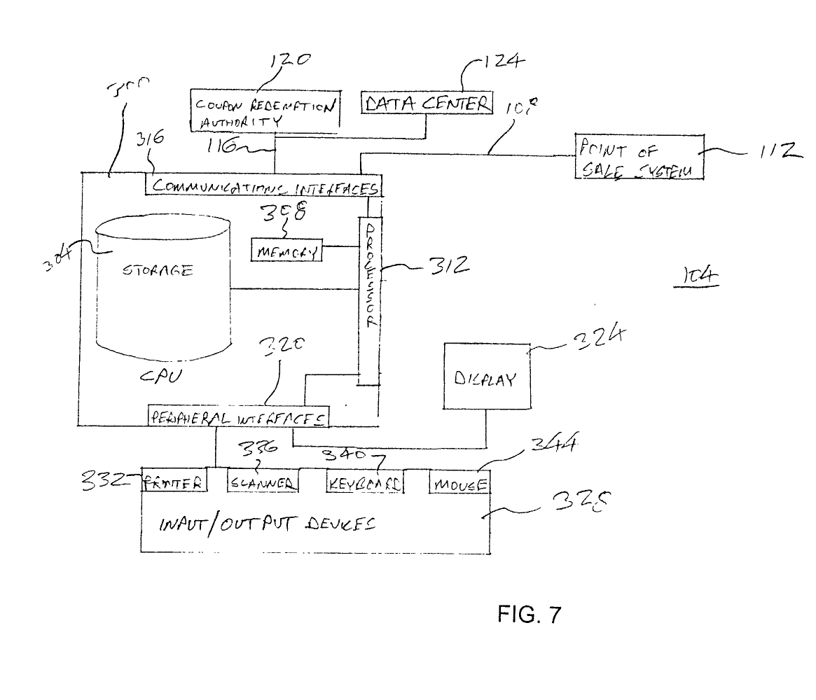

FIG. 7 is a block diagram representing the coupon redemption subsystem 104. As shown in FIG. 3, the coupon redemption subsystem 104 includes a central processing unit (CPU) 300 having data or information storage 304, program memory 308 and a processor 312. The CPU 300 may also include communications interfaces 316 and peripheral interfaces 320. Peripheral devices associated with the coupon redemption subsystem 104 may include a display 324, such as a cathode ray tube (CRT) or flat panel display, including a touch screen type display, and various input/output devices 328. The input/output devices 328 may include a printer 332, a scanner 336, a keyboard 340, and a mouse or other pointing device 344.

In general, at least one of the communications interfaces 316 cooperates with the communications channel 108 and at least one of the communications interfaces 216 of the point of sale subsystem 112 to pass information between the coupon redemption subsystem 104 and the point of sale subsystem 112. As noted above, the communications channel 108 may comprise a variety of channel types. In particular, where the communications channel 108 comprises a conventional local or wide area network, the communications interfaces 216 and 316 may comprise appropriate network interface cards. Where the channel 108 comprises a hard wired serial (e.g., RS 232 or USB) or parallel (e.g., SPP or EPP) interconnection, the communications interfaces 216 and 316 may comprise the ports conventionally provided on the CPU 300 or server 200. The communications network 108 may also comprise the public switched telephone network (PSTN), in which case the communications interfaces 216 and 316 may comprise modems. Where the communications channel 108 comprises the Internet, the communications interfaces 216 and 316 may comprise whatever interface is required by the coupon redemption subsystem 104 or the point-of-sale subsystem 112 to establish a connection to the Internet. It should be appreciated that any combination of communications channel 108 types may be utilized, and that the communications interface 216 of the point-of-sale system 112 need not be the same as the communications interface 316 of the coupon redemption subsystem 104. For example, the communications interface 316 of the coupon redemption subsystem 104 may comprise a modem for interconnecting the coupon redemption subsystem 104 and an Internet server (not shown), while the communications interface 216 of the point-of-sale system 112 may comprise a network card for interconnecting the point-of-sale subsystem 112 over a local area network to a server or router (not shown) in communication with the Internet. Accordingly, in the above example, the communications channel 108 comprises the PSTN, the Internet and a local area network.

In addition to conventional techniques for interconnecting computers such as those discussed above, the coupon redemption subsystem 104 and point-of-sale subsystem 112 may be interconnected by a proprietary type communications channel 108. Of course, the communications interfaces 216 and 316 need to be appropriate to the communications channel 108 utilized. For example, the coupon redemption subsystem 104 may “listen in” to activity occurring on the point-of-sale subsystem 112, and make a record of that activity in real time. Such monitoring of the point-of-sale subsystem 112 requires interfaces 216 and/or 316 that are capable of detecting the activity to be monitored and translating that activity into a signal that can be understood by the coupon redemption subsystem 104. The information monitored on the point-of-sale subsystem 112 may include information stored in the storage 204 of the point-of-sale subsystem 112 as part of the operation of the point-of-sale subsystem 112. Alternatively, information transferred between the various input/output devices 228 and the server 200 of the point-of-sale subsystem 112 may be monitored by the coupon redemption subsystem 104 and stored in storage 304.

From the above discussion, it should be appreciated that information may be transferred from the point-of-sale subsystem 112 to the coupon redemption subsystem 104 either in batches, or in real-time. Additionally, it should be appreciated that the communications channel 108 may serve to continuously interconnect the coupon redemption subsystem 104 to the point-of-sale subsystem 112. Alternatively, the channel 108, whether physical or virtual, may interconnect the coupon redemption subsystem 104 to the point-of-sale subsystem 112 only when transfers of information are taking place. In addition to the communications channel 108 interconnecting the coupon redemption subsystem 104 to the point of sale subsystem 112, a second communications channel 116 may be provided to interconnect the coupon redemption subsystem 104 to a coupon redemption authority 120 and/or to a data center 124.

The coupon redemption subsystem 104 may be configured such that it is easily portable. When so configured, coupon verification personnel may carry the coupon redemption subsystem 104 with them to each retailer location. Alternatively, the coupon redemption subsystem 104 may be kept in a back office or other area of the retail location at which the coupons are deemed. In another embodiment, the coupon redemption subsystem 104 may be maintained off-site from the premises of the retail location at which coupons are being redeemed. For example, the coupon redemption subsystem 104 may be at a facility under the control of the coupon verification third party or entity, which location may receive redeemed coupons from one or more different retailers. Accordingly, the coupon redemption subsystem 104 is not located at the check-out station or other area where products are being purchased. The coupon redemption subsystem 104 is usually located at least twenty feet away from at least one check-out station of the retailer, who is utilizing or relying on the services associated with the coupon redemption subsystem 104. Where the coupon redemption subsystem 104 is to remain at the retailer location, it may be provided with an integrated secure storage container (e.g. a safe or lock box) for holding redeemed coupons until the proper redemption of those coupons can be verified by coupon verification personnel.

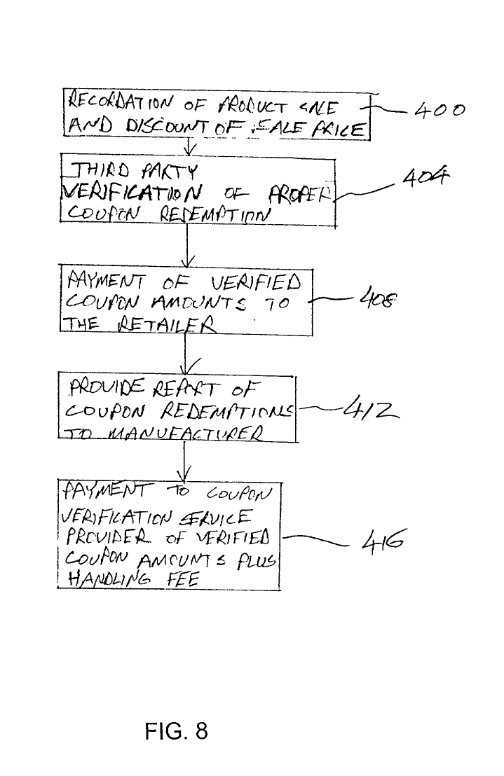

With reference now to FIG. 8, the major operational steps taken in redeeming coupons according to the present invention are illustrated. Initially, at step 400, a record is made of products sold to a consumer during a transaction in the point of sale subsystem 112. In addition, a record is made of any discounts provided by the retailer in connection with the transaction such as those associated with redeemed coupons. These records may be stored in the storage 204 associated with the point of sale subsystem 112. These steps are generally taken by the retailer in the normal course of completing a sale. As should be understood, such records being made related to coupons or other discounts and products being purchased are commonly conducted at each of a number of check-out stations. Regarding coupon transactions, these entail a number of different customers with one or more coupons that are redeemed over a definable time interval. Accordingly, the storage 204 keeps track of product purchases and coupons being redeemed by a number of check-out stations involving a number of different customer purchases or transactions.

At step 404, third party verification of the proper redemption of any coupons associated with a transaction is made using the coupon redemption subsystem 104, as will be discussed in more detail below. Next, at step 408, the retailer is reimbursed for discounts provided to consumers as a result of the proper redemption of coupons. At step 412, a report is provided to each product manufacturer whose coupons have been redeemed. The report provides various information concerning the circumstances of the coupon redemptions in connection with each manufacturer's products. Each manufacturer then makes payment to the third party verification provider in the amount of the reimbursements made to retailers attributable to coupons issued and/or authorized by each product manufacturer, plus a customary handling fee (step 416).

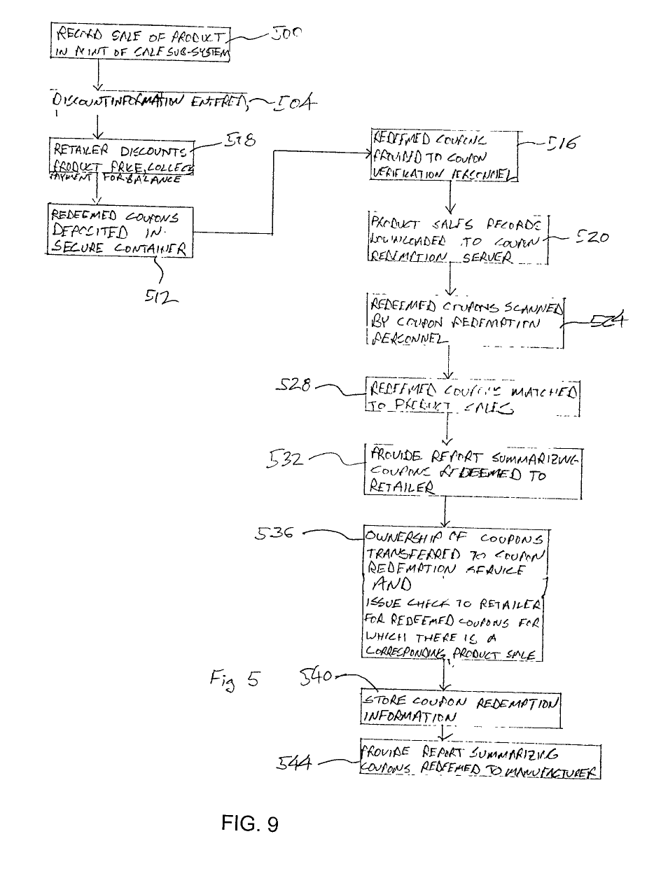

FIG. 9 is a flow chart illustrating the steps of recording sales information (step 400), third party verification of proper coupon redemption (step 404) and payment of verified coupon amounts to the retailer (step 408) illustrated generally in FIG. 8. Initially, at step 500, the sale of a product is entered into the point of sale subsystem 112. The information entered regarding the sale of a product may include such particulars as the product code, batch number, date of manufacture and/or expiration, product size and/or packaging configuration, etc. Information concerning the location of the retailer and information concerning the identity of the consumer may also be stored in connection with the sale of the product, as well as the date and time the transaction was completed. The information recorded concerning the sale of the product may be stored in the storage 204 associated with the server 200 of the point of sale subsystem 112.

The cashier may then, at step 504, enter information concerning any coupons or discounts associated with the sale of a product. For instance, the cashier may enter simply the amount of the discount manually by, for instance, typing that information using the keyboard 240 of the point of sale subsystem 112. Such discount information may or may not be associated with the collection of a coupon authorized by a manufacturer. Therefore, it will be appreciated that a valid coupon is not necessary in order for a cashier to issue a discount using a typical point of sale subsystem 112. Where a discount is associated with a manufacturer authorized coupon, information regarding the discount may also be entered by scanning a bar code provided on the coupon using the scanner 236, by reading coupon information using a coupon reader or other input device, or by manually entering information identifying the coupon. The cashier may also simply enter the amount of the discount provided to the consumer. After the products sold and any discounts have been entered into the point of sale system, payment of the total amount due, plus any taxes or other charges, but less the amount of any discounts entered, is collected from the consumer by the retailer (step 508). Where coupons are associated with the transaction, they are collected by the cashier and placed in a secure storage container or otherwise collected for later verification (step 512). Preferably, a secure storage container is used that allows only the third party verification service provider to access the redeemed coupons following a number of customer transactions or following the cashier's shift. For example, access to the redeemed coupons in the secure container may be made at periodic intervals, such as greater than three hours. Such access or subsequently utilizing the coupon redemption subsystem 104 involves more than one customer. For example, use of the coupon redemption subsystem 104 by coupon verification personnel involves at least ten customers, each of which redeemed at least one coupon.

The secure storage container(s), having the redeemed coupons, is (are) available to coupon verification personnel at step 516. In general, the coupon verification personnel visit retailer locations periodically in order to verify and otherwise process redeemed coupons. Where the volume of redeemed coupons at a retailer location is sufficiently high, for example 500 or more redeemed coupons per day, the coupon verification personnel preferably travel to the retailer location daily to perform the verification procedure. Where coupon volumes do not warrant daily visits by coupon verification personnel, those visits may be less frequent.

At step 520, the records of product sales collected at step 500 are downloaded to the coupon redemption computer or server 300. This download of information may be accomplished in any one of a number of ways. For example, the information may be downloaded from the point of sale subsystem 112 after the coupon verification personnel have arrived at the retailer location. Alternatively, sales records may be downloaded in batches to the coupon redemption system 104 automatically, either at predetermined time intervals or after the occurrence of predetermined events. As a further example, the coupon redemption system 104 may monitor activity occurring in the point of sale subsystem 112 and automatically record sales information in real time. Although the download of information typically occurs over the communications channel 108, it may also be performed by a manual transfer of files containing the information to be downloaded. For example, a removable storage medium, such as a floppy disk, may be used to transfer information from the point of sale subsystem 112 to the coupon redemption subsystem 104.

At step 524, the coupon verification personnel retrieve the redeemed coupons from the secure storage container, and enter coupon identifying information into the coupon redemption subsystem 104. The identifying information may be entered into the coupon redemption subsystem 104 by reading information from the coupons using the scanner 336 or a coupon reader that might be controlled to destroy (e.g. shredding), or otherwise render unuseable, the coupon after it has been verified or accepted. Alternatively, identifying information may be entered manually, such as by using the keyboard 340. Information may be stored in the storage 304, and may include all of the identifying information encoded on the coupon, such as the face value, the product the coupon applies to, the expiration date of the coupon and information concerning the distribution method and/or recipient of the coupon.

It should be noted that steps 520 and 524 may be taken in any order with respect to one another, or they may taken concurrently. Following the completion of steps 520 and 524, the redeemed coupons are matched with product sales by the coupon redemption subsystem 104 (step 528). Information regarding properly redeemed coupons may be stored in the coupon redemption subsystem 104 (step 540). A report summarizing the redemption information may then be provided to the manufacturer (step 544). Preferably, each manufacturer is provided with information concerning the redemption of coupons authorized by the manufacturer in question.

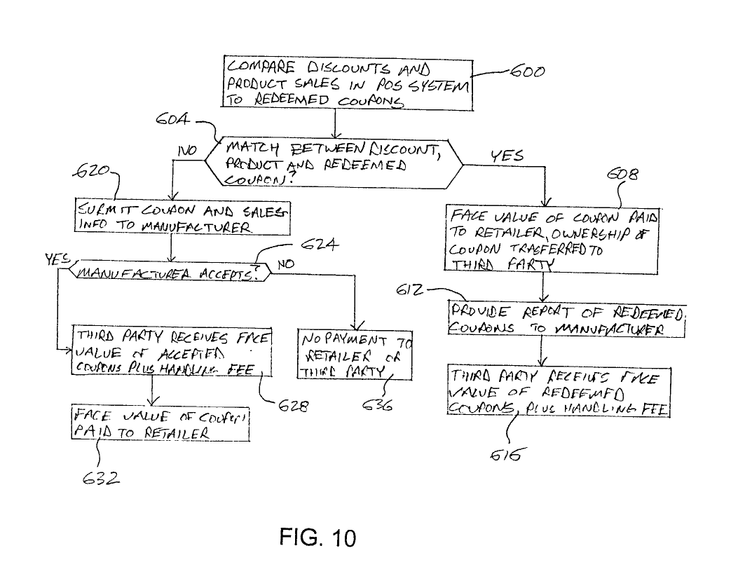

With reference now to FIG. 10, the steps taken in accordance with one embodiment of the present invention in order to verify the proper redemption of coupons are illustrated in detail. At step 600, the discounts and product sales entered in the point-of-sale subsystem 112 and downloaded to the coupon redemption subsystem 104 are compared to the audit or verifying coupons that have been input (e.g. read or scanned) into the coupon redemption subsystem 104 (step 600).

The audit or verifying coupons being accessed were placed in the secure storage container by a person manually carrying the verifying coupons from each check-out station to the location having the secure storage container. In one embodiment, the cashier or other retailer employee manually carries redeemed coupons to be verified for insertion or other placement into the secure storage container, although an employee of the third party verifying entity might perform this task. When all coupons in the secure storage container are properly redeemed coupons, the audit coupons are the same as the redeemed coupons. That is, when coupons are being properly redeemed, there should be no difference between the audit coupons placed in the secure storage container and the redeemed coupons. However, it can occur that there is a difference between the redeemed coupons and the audit coupons. For example, store personnel, such as the cashier, may place in the secure storage container one or more coupons that are not properly redeemed coupons. Such placement could occur inadvertently or intentionally. In such a case, such an audit coupon was probably not scanned by the retailer's scanner.

The coupons to be verified can include rejected coupons that were subsequently redeemed (override coupons), such as those contained in the rejected coupon lock box 26 of the embodiment of FIGS. 1-4. Like other verifying coupons, a determination is made related to whether reimbursement is to be made to either the retail outlet itself or some other entity affiliated with the retail outlet. Additionally or alternatively, the coupon redemption subsystem 104 can be used to verify coupons that were redeemed at a particular check-out lane when one or more components of the of the system 10 (FIGS. 1-4 embodiment) was not functioning properly in connection with determinations related to reimbursement involving that particular check-out lane. In such a case, coupons that were redeemed using the system 10 can be taken to the coupon redemption subsystem for verification and determinations related to reimbursement. Hence, the coupon redemption subsystem 104 can act as a back-up related to whether reimbursement is to be made.

After such information is received, the coupon redemption subsystem 104 then determines whether there is a match between the discount extended, a product sale, and a redeemed coupon (step 604). Generally, a valid match occurs where the amount of the discount is equal to the face value of the coupon, the consumer transaction includes the sale of a product for which the redeemed coupon was issued, and an audit or verifying coupon has been scanned into the coupon redemption subsystem 104 by the third party verification personnel. Accordingly, the coupon redemption subsystem 104 correlates the information scanned into that subsystem by the third party verification personnel to product sale and discount information downloaded from the point-of-sale subsystem 112.

If a proper match is found to exist between the information from the point-of-sale subsystem 112 and the input coupon information, the face amount of the redeemed coupon may be paid to the retailer by the third party verifier or verification service (step 608). Concurrent with or prior to payment of the face value of the redeemed coupons to the retailer, ownership of the verifying coupons is transferred from the retailer to the third party verification service (step 608).

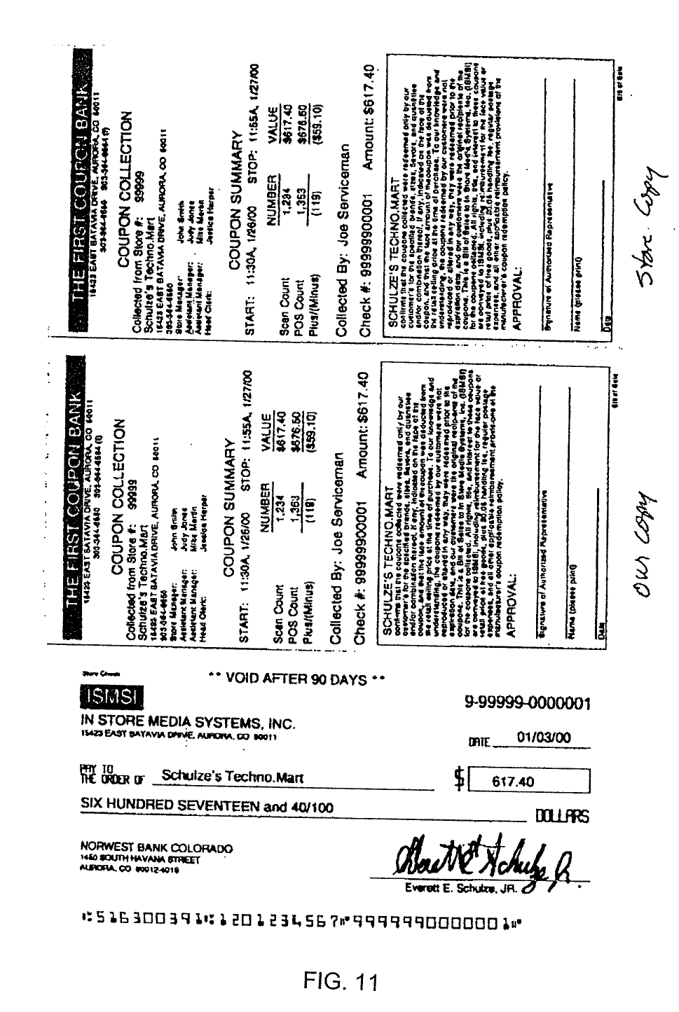

At step 612, a report of the redeemed coupons is provided to the retailer. This report may include information identifying the product and face value of the coupon, and any other information that has been downloaded from the point-of-sale subsystem 112 or scanned or otherwise entered into the coupon redemption subsystem 104 during the coupon verification process. According to one embodiment of the present invention, the report of redeemed coupons, a release of the verifying coupons transferring ownership of those coupons from the retailer to the third party verification service, and a check are printed using the printer 332 of the coupon redemption subsystem 104 at the close of the coupon redemption session. An example of a combined retailer report, release and check is illustrated in FIG. 11. Accordingly, payment of the amounts by which the retailer has properly discounted sales to consumers in response to the receipt of valid coupons may be made immediately following the coupon verification process, and closely following acceptance of the coupon by the retailer. For instance, where the verification process is conducted daily, reimbursement for discounts extended to consumers by the retailer can be provided to the retailer daily. Alternatively, a check may be issued by a central office of the coupon verification service, or an electronic funds transfer may be made. Reimbursement is made to the retailer within at least ten days of the completion of the coupon verification process and, preferably, within five days of the retailer crediting the customer for the coupon amount. More preferably, payment is made to the retailer immediately (same day or next day) following completion of the verification process.

According to one embodiment of the present invention, information concerning the redemption of coupons may be transmitted from the CPU 300 of the coupon redemption subsystem 104 to a data center 124 over the second communication channel 116. Preferably, the data center 124 collects and collates information received from various coupon redemption subsystems 104. The third party verification service may then provide each manufacturer with a comprehensive report of coupon redemptions. These reports may contain any of the information downloaded to, scanned by, or otherwise collected by the coupon redemption system 104 (step 612). According to one embodiment of the present invention, the information stored in the data center 124 may be accessible by the manufacturer directly. For instance, manufacturers may be allowed to search the data center using a connection established over the Internet. Alternatively, reports may be prepared by the third party verification service and provided to the manufacturer. According to one embodiment of the present invention, the manufacturer may specify the format of and information included in the provided report. For instance, the manufacturer may request information concerning selected time periods or regions of various scope. The manufacturer may also request information concerning particular retailers, stores or even lanes in a store. Information on the report may also be limited to particular categories or product codes. Additionally, information regarding redeemed coupons may be limited to particular family, offer or value codes. The report may also include coupons verified electronically and/or manually.

Within the general queries formulated by selecting items such as those described above, the returned information may be subdivided into various groupings. For instance, the information may be grouped according to the time period, region, retailer, product, coupon or clearing method. Furthermore, reports maybe requested in summary form, or as complete listings.

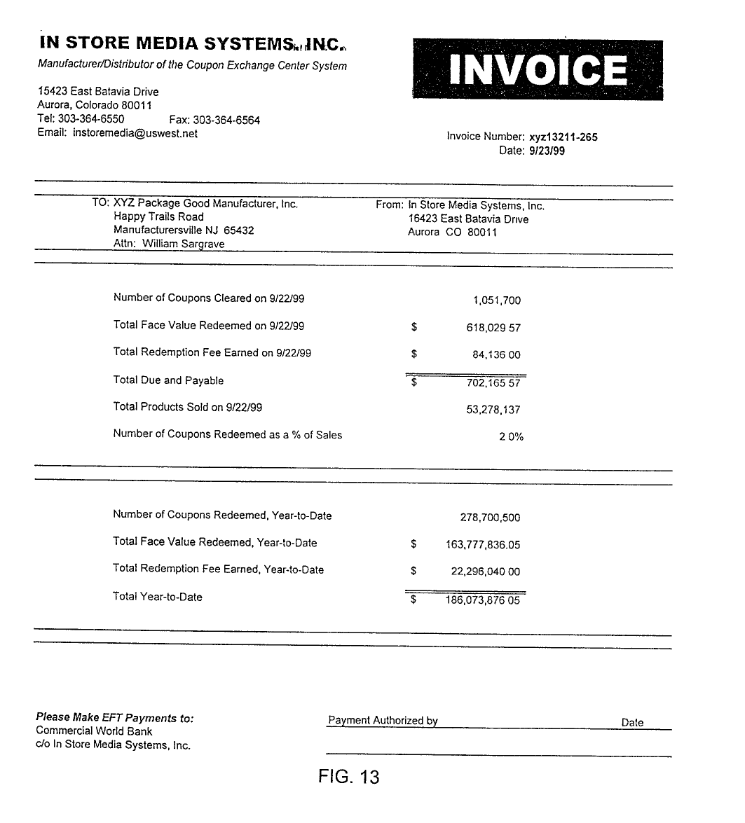

In order to obtain reimbursement for amounts paid to retailers on behalf of the product manufacturers, as illustrated in FIG. 13, the third party verification service may provide an invoice to each product manufacturer. The invoice may summarize such items as the number of coupons verified, the total face value of the coupons, a calculation of the redemption fee, and a total amount owed to the third party verification service. In addition to providing such information for the period covered by the invoice (e.g. a single day), the invoice may provide year-to-date information. A report, as described above, may be enclosed with the invoice.

Optionally, the manufacturer may also be provided with the original verifying coupons. If the manufacturer desires, it may conduct its own audit of the verifying coupons and the report of discounts paid for by the third party verification service.

Following receipt of the invoice, the manufacturer may make payment to the third party verification service in the amount of the face value of the redeemed coupons, plus the handling fee (step 616).

If at step 604 a match cannot be made among a discount, product sale and an input coupon, the verifying coupons are sent to the manufacturer for processing (step 620). The processing by the manufacturer may comprise the steps conventionally taken by the manufacturer to verify the proper redemption of coupons. Accordingly, the provision of verifying coupons to the manufacturer may comprise the provision of all unmatched coupons relating to the manufacturer to the manufacturer's agent for examination. In addition, the manufacturer or manufacturer's agent may be provided with information collected by the point-of-sale system 112 and/or information entered into the coupon redemption system 104. For instance, such information may be provided to a coupon redemption authority 120 using the second communications channel 116.

If the manufacturer decides to accept the coupon (step 624) the third party verification service receives the face value of the accepted coupon plus a handling fee (step 628). The face value of the accepted coupons may then be paid by the third party verification service to the retailer (step 632). A manufacturer may choose to accept an improperly redeemed coupon for a variety of reasons. For instance, the manufacturer may wish to maintain cordial relationships with its retailers. In addition, in view of the detailed sales information that may be provided by the present invention, even in connection with redemptions not verified by the third patty service, the manufacturer may find that consumers are redeeming coupons intended for particular product configurations for alternate configurations. For example, the manufacturer may issue a coupon intended only for a product in a particular packaging configuration or in particular flavor, but may nonetheless honor the coupon if redeemed in connection with the sale of the product in some other package or flavor. In addition to using the detailed sales information for determining whether a redemption was “close enough,” the manufacturer may also use the information to persuade the retailer to stock a particular flavor or product configuration, thereby allowing the manufacturer to increase the amount of shelf space allocated to it in the retailer's store.

If at step 624 the manufacturer does not accept the particular coupon that was audited, no payment is made to the third party verification service, and accordingly no payment is made to the retailer in connection with the redemption of the rejected coupon (step 636). In another embodiment, the third party verifier may decide unilaterally to reimburse the retailer for the unverified coupon. In such a case, the third party verifier may seek reimbursement from the manufacturer by providing the manufacturer with a report that identifies such an unverified coupon.

It can be appreciated that some overlap may occur between product sales recorded in the point of sale subsystem 112 and the audit coupons removed from the secure storage container by the coupon verification personnel. For example, and in particular where product sales information is downloaded at the time the coupon verification personnel arrive at the retailer, or where such information is provided to the coupon redemption system 104 continuously, discounts extended by the retailer to consumers may be entered in the point of sale system 112 that do not have corresponding audit coupons in the secure storage container. For example, information may have been downloaded to the coupon redemption system 104 before the cashier (or other individual) has had the opportunity to place the redeemed coupon associated with such a sale in the secure storage container (which redeemed coupon then becomes the verifying or audit coupon) for review by the coupon verification personnel. In such instances, product sales and associated discounts for which no match with an audit coupon was made may be retained in the coupon redemption subsystem 104 until a subsequent coupon verification session.

A further explanation of such overlap is provided by the following example. Assume that the coupon redemption subsystem 104 conducts a first audit session of a first plurality of coupons and then conducts a second audit session of a second plurality of coupons. The first plurality of coupons includes a number of sets of audit coupons, with each set being associated with a different customer and a corresponding different transaction involving one or more coupons for that customer. Likewise, the second plurality of coupons includes a number of sets of coupons, with each set involving a different customer redeeming one or more coupons. At a desired or predetermined time at which these first plurality of coupons are located in the secure storage container, the coupon verification entity removes all of these first plurality of coupons for verification using the coupon redemption subsystem 104. During the time that the coupon redemption subsystem 104 is conducting its verification process associated with the first plurality of coupons, the POS subsystem 112, as an example, inputs or otherwise provides coupon information for a number of customers totaling ten different coupons. Consequently, the coupon redemption system 104 has coupon information for at least ten coupons for which there will be no match or correspondence with the coupons then being audited during the first audit session. The coupon information for each of these ten coupons is stored in a properly identified file or storage area for subsequent access and comparison during the second audit session involving the second plurality of audit coupons. In that regard, it is anticipated that the second plurality of audit coupons includes coupons having information corresponding to the overlap coupon information that is kept in the properly identified storage area of the coupon redemption subsystem 104. As a result, such previously stored information is also invoked or relied on in conducting the verifying procedures or steps previously discussed. In the present example, the ten coupons for which there was no match or correspondence during the first audit session are taken into account during the second audit session. Under usual circumstances, the coupon information associated with each of these ten coupons is expected to be matched with the audit coupons that are part of the second audit session. As can be understood, there may be overlap coupon information input from the POS subsystem 112 during each of the coupon audit sessions conducted by the coupon redemption subsystem 104, with such overlap coupon information to be taken into account during one or more later coupon audit sessions.

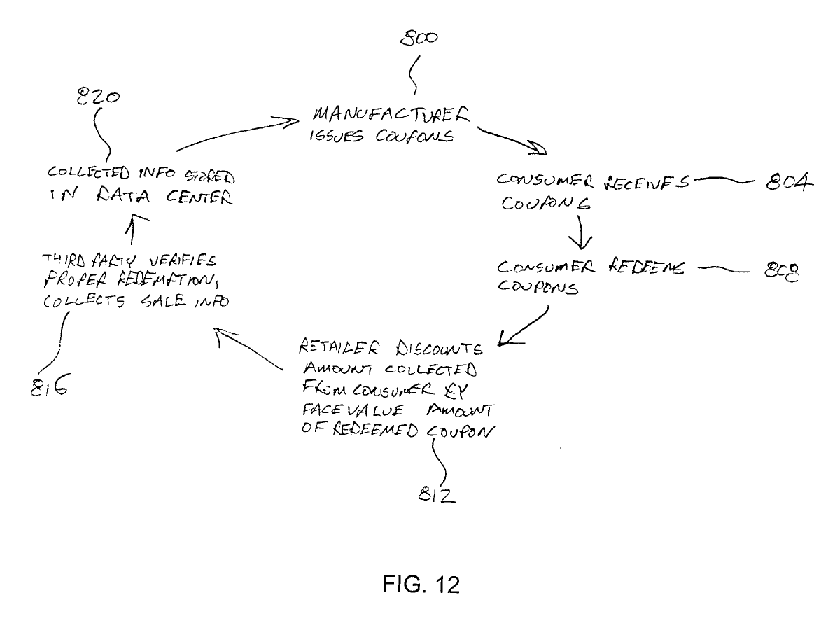

With reference now to FIG. 12, the flow of information between the parties involved in the redemption of a coupon according to the present invention is illustrated. Initially, the manufacturer 800 issues or authorizes the issuance of coupons to the consumer 804. The consumer selects the coupons that he or she wishes to use, and redeems them in connection with the purchase of a product 808. At step 812, the retailer extends a discount to the consumer in the amount of the face value of the coupon and takes possession of the coupon. Audit or verifying coupons are then provided to the third party verification service for verification of proper redemption 816. Information collected during the verification process is stored in the data center 120 (step 820) and made available to the manufacturer. Accordingly, the manufacturer is provided with feedback concerning the redemption of authorized coupons. This feedback allows the manufacturer to adjust its promotions in response to consumer demand. The feedback to the manufacturer by the present invention is provided very quickly, as the information concerning the coupon redemption is collected electronically, and may, according to one embodiment, be accessed by the manufacturer almost immediately following collection.

Although the present invention has been described in conjunction with its preferred embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method for redeeming coupons, comprising:
identifying products, including at least first, second and third products being purchased, at a purchasing outlet, said first and second products being produced by first and second product providers, respectively;
reading firstly a first coupon from a first customer at the purchasing outlet;
determining, at the purchasing outlet, that said first coupon is to be redeemed;
modifying, at the purchasing outlet, said first coupon after said determining step for said first coupon, wherein said determining step cannot again be conducted for said first coupon after said modifying step because of one or more modifications made to said first coupon during said modifying step;
providing said first coupon, after said modifying step, in a first container;
reading secondly a second coupon from the first customer at the purchasing outlet, wherein said second coupon is the next coupon read after said first coupon;
making a determination related to whether said second coupon is to be redeemed after said reading secondly step;
storing, after said making step, said second coupon in a second container, different from said first container;
reading a third coupon at the purchasing outlet;
ascertaining that said third coupon is to be rejected;
deciding not to reject said third coupon; and
locating said third coupon in a third container, different from said first and second containers;
reimbursing firstly for said first coupon;
reimbursing secondly for said second coupon at a time different from said reimbursing firstly step, wherein each of said reimbursing firstly and said reimbursing secondly steps is made by a third party different from the first and second providers of the first and second products associated with said first and second coupons, respectively.

2. A method, as claimed in claim 1, further including:
recording transaction information related to said third coupon;
retrieving said third coupon from said third container; and
checking whether reimbursement is to be made for said third coupon.

3. A method, as claimed in claim 1, wherein:
said second coupon is stored depending on a number of factors including whether said second coupon is submitted for redemption at a particular store and whether said second coupon is submitted for redemption during a particular time.

4. A method, as claimed in claim 1, further including:
removing said third coupon from said third container;
obtaining information from said third coupon using a coupon redemption subsystem at a location different from the purchasing outlet; and
using said information in determining whether to reimburse for said third coupon.

5. A method, as claimed in claim 1, wherein:
said identifying step is conducted using a product reader device and each of said reading firstly and secondly steps is conducted using a coupon reader device.

6. A method, as claimed in claim 1, wherein:
said reimbursing firstly step is made to an entity associated with the purchasing outlet within about one day after said providing step and said reimbursing secondly step is made to the entity more than one day after said storing step.

7. A method, as claimed in claim 1, wherein:
said first container includes a modified coupon lock box unit, said second container includes an audit coupon lock box unit and said third container includes a rejected coupon lock box unit.

8. A method, as claimed in claim 1, further including:
reimbursing the third party service provider by the first product provider after said reimbursing firstly step.

9. The method, as claimed in claim 1, further including:
removing said third coupon from said third container and taking said third coupon to a coupon redemption subsystem that includes an auxiliary coupon reader device that reads said third coupon.

10. A system for redeeming coupons, comprising:
a device that reads a first coupon, a second coupon, and a third coupon, wherein at least said first and second coupons are from a first customer and said second coupon is read next after said first coupon;
processing apparatus in operative communication with said device, said processing apparatus determining that said first coupon is to be redeemed and modified, determining that said second coupon is to be redeemed and audited, and determining that said third coupon is to be rejected;
a first storage unit that stores said first coupon;
a second storage unit that stores said second coupon;
a third storage unit that stores said third coupon, wherein said device, said processing apparatus, and each of said first, second and third storage units are located at purchasing outlet at which said first, second, and third coupons are presented for redemption; and
means for issuing payment related to reimbursement for redemption of said first coupon and said second coupon, said means for issuing payment being operated to reimburse for said second coupon at a time different from being operated to reimburse for said first coupon.

11. A system, as claimed in claim 10, wherein:
said processing apparatus generates a report that includes information related to said second coupon including an identity of the purchasing outlet, an identity of a purchasing outlet lane at which said second coupon was submitted for redemption, and a time at which said second coupon was submitted for redemption.

12. An apparatus, as claimed in claim 10, wherein:
said device is a coupon reader device and the system further includes a product reader device different from said coupon reader device.

13. A system, as claimed in claim 10, further including:
a coupon redemption subsystem that is provided at a location different from the purchasing outlet, said coupon redemption system including an auxiliary coupon reader device and a processor that receives information obtained by said processing apparatus related to said third coupon.

14. A system, as claimed in claim 10, wherein:
said means for issuing payment includes at least one of a check writer and a wire transfer to an account.
